(19) United States
(12) Patent Application Publication
(10) Pub. No.: US 2022/0055469 A1
(43) Pub. Date: Feb. 24, 2022

(54) IMPACT FORCE ABSORPTION UNIT FOR ELECTRICAL ENERGY STORAGE DEVICE

(71) Applicant: Valeo Systemes Thermiques, Le Mesnil Saint Denis Cedex (FR)

(72) Inventors: Jerome Ripa, Le Mesnil Saint Denis Cedex (FR); Sergio Da Costa Pito, Le Mesnil Saint Denis Cedex (FR); Stephan Andre, Le Mesnil Saint Denis Cedex (FR); Emmanuel Henon, Le Mesnil Saint Denis Cedex (FR)

(73) Assignee: Valeo Systemes Thermiques, Le Mesnil Saint Denis Cedex (FR)

(21) Appl. No.: 17/414,075

(22) PCT Filed: Dec. 2, 2019
(86) PCT No.: PCT/FR2019/052877

§ 371 Date: Jun. 15, 2021

(30) Foreign Application Priority Data
Dec. 17, 2018 (FR) 1873070

(51) Int. Cl. B60K 1/04; B62D 21/15; H01M 50/209; H01M 50/242

(52) U.S. Cl. CPC B60K 1/04; B62D 21/15; H01M 2220/20; H01M 50/242; H01M 50/209

(57) ABSTRACT

The invention relates to an impact force absorption unit (30) for an electrical energy storage device for a motor vehicle, the unit comprising at least one insert made of a first material and a plastic body within which the insert (31) is placed, the insert and the body (33) being connected to each other, the insert being designed to be arranged in a region exposed to an impact on the motor vehicle, in particular a side impact on the vehicle.

The present invention relates to the field of an impact energy absorption unit for a motor vehicle electrical energy storage device.

Currently, battery housings are mainly made of metals, steel and/or aluminum, which offer both stiffness and strength. One of the main functions of the battery housing is to protect the cells of the battery from collision situations, in particular lateral collisions, which can prove critical.

A battery device with shock absorption elements with an aluminum foam is known from the patent KR101274470.

The invention aims to improve the protection of the battery elements during an impact, in particular a lateral impact, while at the same time allowing better integration into the vehicle.

To this end, one subject of the invention is an impact energy absorption unit for an electrical energy storage device for a motor vehicle, this unit comprising at least one insert made of a first material and a plastic body within which the insert is placed, this insert and this body being connected to one another, this insert being intended to be disposed in a region that is exposed to an impact of the motor vehicle, in particular a lateral impact of the vehicle.

The invention is remarkable in that it makes possible an absorption unit that is lighter in weight than existing all-metal solutions, which remain heavy. The invention also allows more integration opportunities on account of the use of plastic. In addition, the invention makes it possible to maintain, on account of the one or more inserts, satisfactory stiffness and solidity of the unit according to the invention.

According to one of the aspects of the invention, the unit has two inserts placed within the plastic body and connected thereto, these inserts being in particular placed in two regions of the plastic body, which regions are in particular perpendicular to one another, one of the regions being that which is exposed to an impact of the motor vehicle, in particular a lateral impact of the vehicle.

According to one aspect of the invention, the one or more inserts comprise a composite material with glass and/or carbon fibers, or these one or more inserts are made of metal, in particular steel or aluminum.

According to one aspect of the invention, the insert in the region that is exposed to an impact of the motor vehicle, called the first insert, has a shape that is open in the direction away from the other insert, this first insert having in particular a C shape in cross section, preferably with a lower arm and an upper arm that are parallel to one another.

According to one aspect of the invention, the second insert, which is behind the exposed region in which the first insert extends, has an S or C shape in cross section.

According to one aspect of the invention, the first and second inserts extend substantially as far as at least one edge of the plastic body, in particular the first and second inserts are superimposed with the plastic body over at least 80%, or even 90%, of the surface area of the inserts. Thus, the inserts occupy a large area of the plastic body, in other words there are few parts of the plastic body that are not connected to the inserts.

According to one aspect of the invention, taken alone or in combination, it will be possible to provide that:
a. the plastic body has two perpendicular regions, and each insert is disposed in one of these regions, the body preferably being formed in one piece;
b. the plastic body has a plurality of ribs, the plastic body preferably being a perforated body formed by a plurality of rows of ribs that form a network of ribs, these ribs resting in particular for the majority on the inserts;
c. the ribs extend over a face or a plurality of faces of each insert, these ribs forming parallel rows and other, perpendicular, rows;
d. the plastic body is made of plastic material that is preferably reinforced with fibers, in particular glass or carbon fibers;
e. the two inserts are preformed or formed during the overmolding, depending on the complexity of the shape of the inserts;
f. the inserts are preferably welded and/or mechanically connected during the overmolding of the plastic body.

The invention also relates to an electrical energy storage device for a motor vehicle, comprising a plurality of battery cells and a unit as described above, the cells being in particular placed in a housing and the absorption unit being placed on one side of this housing so as to protect this housing from a lateral impact of the vehicle, in particular two absorption units as described above being provided, each being disposed on one lateral side of the housing that receives the battery cells, these two lateral sides being in particular parallel to one another.

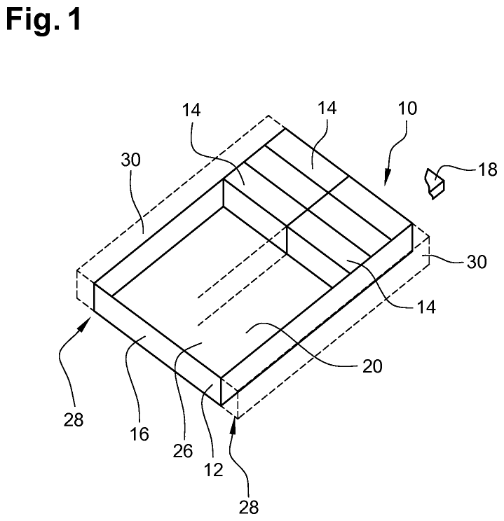

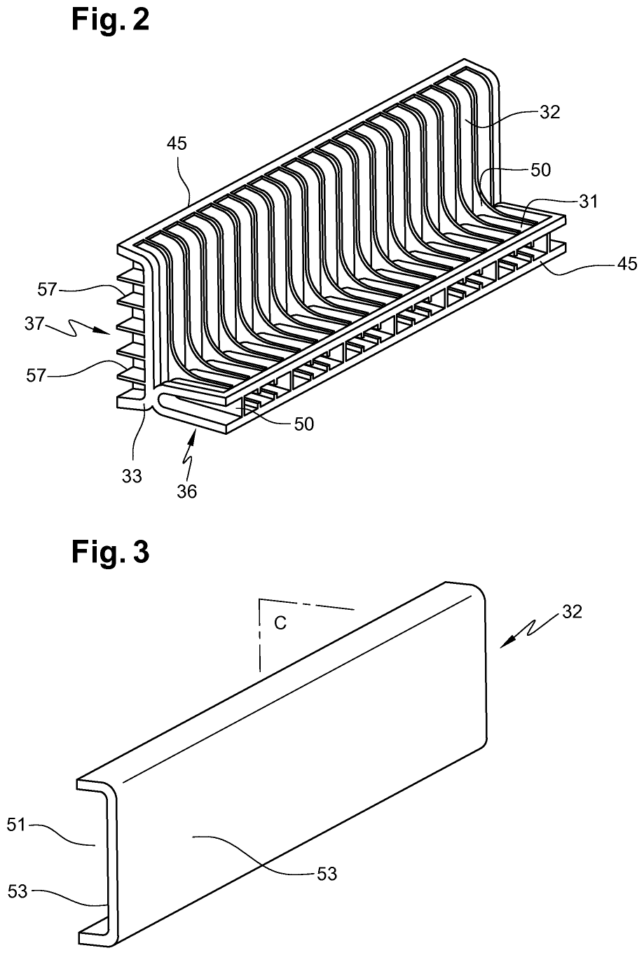

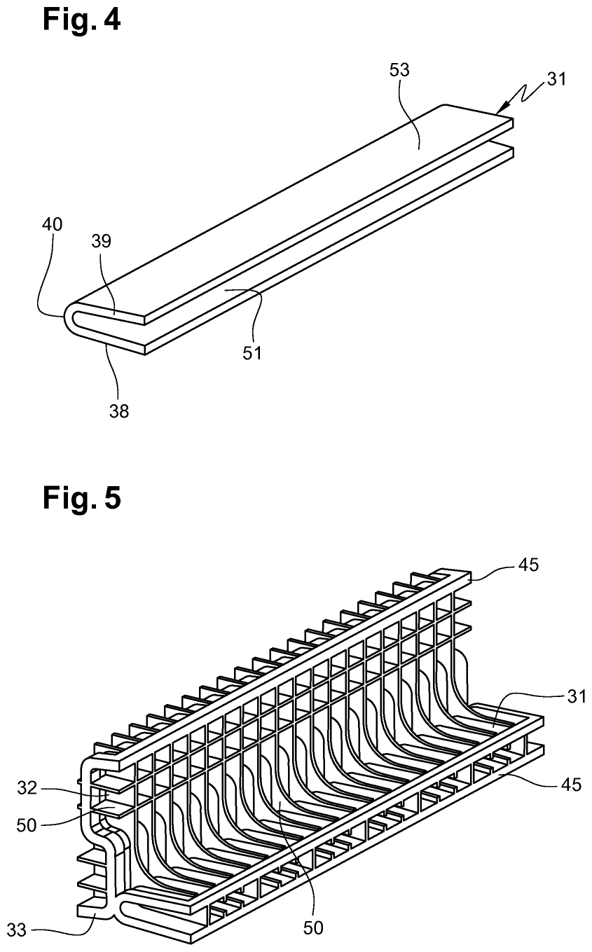

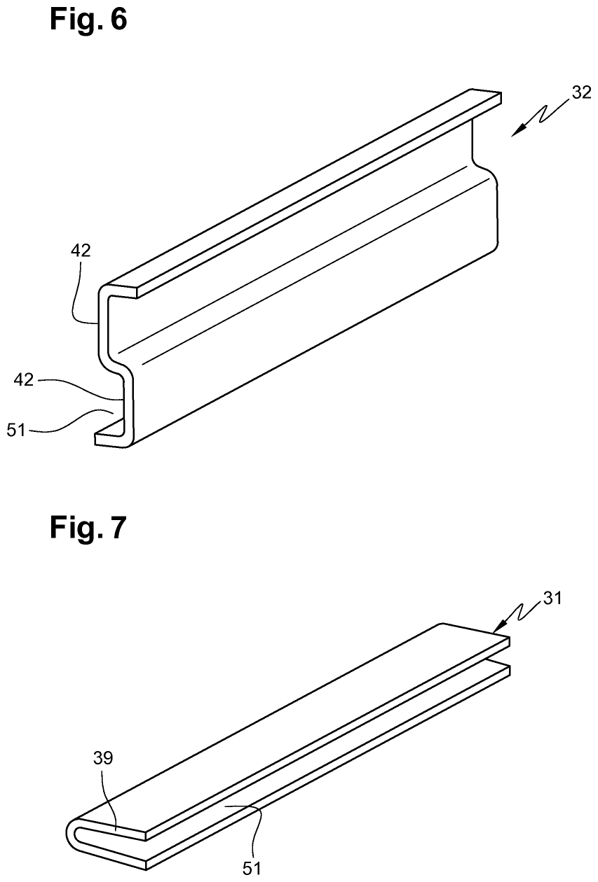

Further features and advantages of the invention will become more clearly apparent upon reading the following description, which is given by way of illustrative and non-limiting example, and the appended drawings, in which:

[FIG. 1] shows a diagram of a battery cell device according to an example of the invention;

[FIG. 2], [FIG. 3] and [FIG. 4] show different absorption unit elements according to an example of the invention;

[FIG. 5], [FIG. 6] and [FIG. 7] show different absorption unit elements according to another example of the invention.

FIG. 1 shows an electrical energy storage device 10 for a motor vehicle. The motor vehicle can in particular be a car, a truck, a bus. The electrical energy storage device 10 has a housing 12 and cells 14 for storing electrical energy. The cells 14 are for example electrically connected in series. The housing 12 is formed of a lower compartment 16 and an attached part 18 intended to close the housing 12 so as to protect the cells 14. In this case, the attached part 18 is a cover, which covers a recess 20 defined by the part 16. The compartment 16 has the shape of a bowl, with a bottom wall 26 and lateral walls 28. These lateral walls 28 are exposed to the risk of lateral impact of the motor vehicle, these walls extending parallel to the fenders of the vehicle in particular.

This compartment 16 and the cover 18 are for example each made from a sheet of composite material, in particular comprising glass fibers, possibly as a variant carbon fibers or other fibers, pre-impregnated with a thermoplastic resin.

Two impact energy absorption units 30 are provided for the electrical energy storage device 10, disposed on each of the lateral walls 20.

In the example illustrated in [FIG. 2], [FIG. 3] and [FIG. 4], each unit 30 has two inserts 31 and 32 made of first materials and a plastic body 33 within which the inserts are placed.

These inserts 31 and 32 and this body 33 are connected to one another.

These two inserts 31 and 32 are placed within the plastic body 33, in two regions 36 and 37 of the plastic body 33, which regions are perpendicular to one another, one of the regions 36 being that which is exposed to an impact of the motor vehicle, in particular a lateral impact of the vehicle.

The inserts 31 and 32 comprise a composite material with glass and/or carbon fibers, or these one or more inserts 31 and 32 are made of metal, in particular steel or aluminum.

The insert 31 in the region that is exposed to an impact of the motor vehicle, called the first insert, has a shape that is open in the direction away from the other insert, this first insert having in particular a C shape in cross section, with a lower arm 38 and an upper arm 39 that are parallel to one another and are connected to one another by a rounded elbow 40.

The second insert 32, which is behind the exposed region 36 in which the first insert 31 extends, has a C shape in cross section C.

Alternatively, as illustrated in [FIG. 5], [FIG. 6] and [FIG. 7], the insert 32 can have an S shape, with concavities directed in opposite directions, with elbows 42 that are rectilinear over a part of their height. The first insert 31 is identical to that of the previous example.

The first 31 and second 32 inserts extend substantially as far as a plurality of edges 45 of the plastic body 33, in particular the first and second inserts 31 and 32 are superimposed with the plastic body over at least 80%, or even 90%, of the surface area of the inserts. Thus, the inserts occupy a large area of the plastic body, in other words there are few parts of the plastic body that are not connected to the inserts.

The plastic body 33 has two perpendicular regions 36 and 37, and each insert 31, 32 is disposed in one of these regions, the body 33 being formed in one piece.

The plastic body 33 has a plurality of ribs 50, the plastic body preferably being a perforated body formed by a plurality of rows of ribs that form a network of ribs 50, these ribs resting in particular for the majority on the inserts 31 and 32.

In particular the ribs 50 extend in the concavities 51 of the inserts 31 and 32.

The ribs 50 extend over a plurality of faces 53 of each insert 32 and 32, these ribs forming parallel rows 57 and other, perpendicular, rows.

The plastic body 33 is made of plastic material that is preferably reinforced with fibers, in particular glass or carbon fibers.

The inserts 31, 32 are preferably welded and/or mechanically connected during the overmolding of the plastic body so as to form the body 33.

1. An impact energy absorption unit for an electrical energy storage device for a motor vehicle, the impact energy absorption unit comprising:
at least one insert made of a first material and a plastic body within which the insert is placed, the at least one insert and the plastic body being connected to one another,
wherein the at least one insert is configured to be disposed in a region that is exposed to a lateral impact of the motor vehicle.

2. The unit as claimed in claim 1, further comprising: two inserts placed within the plastic body and connected thereto, wherein the two inserts are placed in two regions of the plastic body perpendicular to one another, one of the two regions being that which is exposed to the lateral impact of the motor vehicle.

3. The unit as claimed in claim 2, wherein the two inserts comprise a composite material with glass and/or carbon fibers, or are made of steel or aluminum.

4. The unit as claimed in claim 3, wherein the insert in the region that is exposed to the lateral impact of the motor vehicle, called the first insert, has a shape that is open in the direction away from the other insert, first insert having a C shape in cross section, with a lower arm and an upper arm that are parallel to one another.

5. The unit as claimed in claim 3, wherein the second insert, which is behind the exposed region in which the first insert extends, has an S or C shape in cross section.

6. The unit as claimed in claim 1, wherein the plastic body has a plurality of ribs, the plastic body being a perforated body formed by a plurality of rows of ribs that form a network of ribs, these ribs resting, in a majority, on the at least one.

7. The unit as claimed in claim 1, wherein the ribs extend over a face or a plurality of faces of each insert, the ribs forming parallel rows and forming perpendicular rows.

8. The unit as claimed in claim 1, wherein the plastic body is made of plastic material reinforced with glass or carbon fibers.

9. The unit as claimed in claim 1, wherein the one or more inserts are welded and/or mechanically connected during the overmolding of the plastic body.

10. An electrical energy storage device for a motor vehicle, comprising:
a plurality of battery cells; and
two impact energy absorption units for an electrical energy storage device for a motor vehicle, the impact energy absorption units comprising:
at least one insert made of a first material and a plastic body within which the insert is placed, the at least one insert and the plastic body being connected to one another,
wherein the at least one insert is configured to be disposed in a region that is exposed to a lateral impact of the motor vehicle,
the plurality of cells being placed in a housing and the absorption units being placed so as to protect this housing from the lateral impact of the vehicle, each of the two absorption units being disposed on one lateral side of the housing that receives the battery cells, the two lateral sides being parallel to one another.
